(19) United States
(12) Patent Application Publication
(10) Pub. No.: US 2021/0090013 A1
(43) Pub. Date: Mar. 25, 2021

(54) STORE STOCK NOTIFYING SYSTEM, STORE STOCK NOTIFYING METHOD, AND PROGRAM

(71) Applicant: TOSHIBA TEC KABUSHIKI KAISHA, Tokyo (JP)

(72) Inventor: Nobuhiro Inagawa, Numazu Shizuoka (JP)

(21) Appl. No.: 16/914,668

(22) Filed: Jun. 29, 2020

(30) Foreign Application Priority Data
Sep. 19, 2019 (JP) 2019-170023

(51) Int. Cl. G06Q 10/08; G06Q 30/06

(52) U.S. Cl. CPC G06Q 10/087; G06Q 30/0633; G06Q 30/0623; G06Q 30/0641

(57) ABSTRACT

A store stock notifying system includes a commodity stock database for managing stock information of commodities in a store, a customer information database for managing customer information, a purchase-planned-commodity registering unit configured to receive registration of a purchase planned commodity from a customer, a customer-store-visit detecting unit configured to detect a store visit of a customer registered in the customer information database, and a stock-information notifying unit configured to, if the customer-store-visit detecting unit detects the store visit of the customer, acquire stock information of the purchase planned commodity from the commodity stock database and notify the stock information to the customer.

### CROSS-REFERENCE TO RELATED APPLICATION

This application is based upon and claims the benefit of priority from Japanese Patent Application No. 2019-170023, filed in Sep. 19, 2019, the entire contents of which are incorporated herein by reference.

### FIELD

Embodiments described herein relate generally to a store stock notifying system, a store stock notifying method, and a program.

### BACKGROUND

There has been present a system that grasps commodity stocks in a store and enables, in association with an EC site or the like, customers (users) to confirm stock information (stock quantities) (see JP-A-2017-220006 (Patent Literature 1)). The customers can confirm a commodity stock situation before visiting the store by using such a system.

However, a commodity stock quantity of the store unstably changes. Accordingly, the customers sometimes give up commodity purchase because commodities are out of stock or are short of stock when the customers visit the store.

Therefore, simple introduction of such a system cannot meet the needs of the customers.

### DESCRIPTION OF THE DRAWINGS

FIG. 1 is a schematic diagram illustrating a store stock notifying system in an embodiment;

FIG. 2 is a diagram illustrating a hardware configuration of the store stock notifying system;

FIGS. 3A to 3D are diagrams illustrating a data table: FIG. 3A illustrating commodity information, FIG. 3B illustrating customer information, FIG. 3C illustrating commodity purchase history information, and FIG. 3D illustrating purchase planned commodity information;

FIG. 4 is a sequence chart illustrating a store stock notifying method in the embodiment;

FIG. 5 is a diagram illustrating a display example of stock information of a purchase planned commodity;

FIG. 6 is a sequence chart illustrating a modification of the store stock notifying method; and

FIG. 7 is a diagram illustrating a display example of stock information of a purchase planned commodity.

### DETAILED DESCRIPTION

An object of embodiments is to provide a store stock notifying system and a store stock notifying method that can notify stock information of a purchase planned commodity to a customer visiting a store.

A store stock notifying system according to an embodiment includes: a commodity stock database for managing stock information of commodities in a store; a customer information database for managing customer information; a purchase-planned-commodity registering unit configured to receive registration of a purchase planned commodity from a customer; a customer-store-visit detecting unit configured to detect a store visit of a customer registered in the customer information database; and a stock-information notifying unit configured to, if the customer-store-visit detecting unit detects the store visit of the customer, acquire stock information of the purchase planned commodity from the commodity stock database and notify the stock information to the customer.

In the store stock notifying system according to the embodiment, the customer-store-visit detecting unit may be a storefront terminal, and the stock-information notifying unit may cause the storefront terminal to display the stock information.

In the store stock notifying system according to the embodiment, the customer information may include information concerning a portable information terminal carried by the customer, and the stock-information notifying unit may transmit the stock information to the portable information terminal via an electric communication line.

In the store stock notifying system according to the embodiment, if a stock quantity of the purchase planned commodity is smaller than a purchase planned quantity, the stock-information notifying unit may acquire information concerning a substitute of the purchase planned commodity from the commodity stock database and notify the information concerning the substitute to the customer.

A store stock notifying method according to an embodiment includes: receiving registration of a purchase planned commodity from a customer registered in a customer information database; and, if a store visit of the customer is notified by a customer-store-visit detecting unit, acquiring stock information of the purchase planned commodity from a commodity stock database and notifying the stock information to the customer.

A program according to an embodiment causes a computer to function as: purchase-planned-commodity registering means for receiving registration of a purchase planned commodity from a customer registered in a customer information database; and stock-information notifying means for, if a store visit of the customer is notified from a customer-store-visit detecting unit, acquiring stock information of the purchase planned commodity from a commodity stock database and notifying the stock information to the customer.

A store stock notifying system and a store stock notifying method in an embodiment are explained below with reference to the drawings. In the drawings, the same components are denoted by the same reference numerals and signs.

<Store Stock Notifying System>

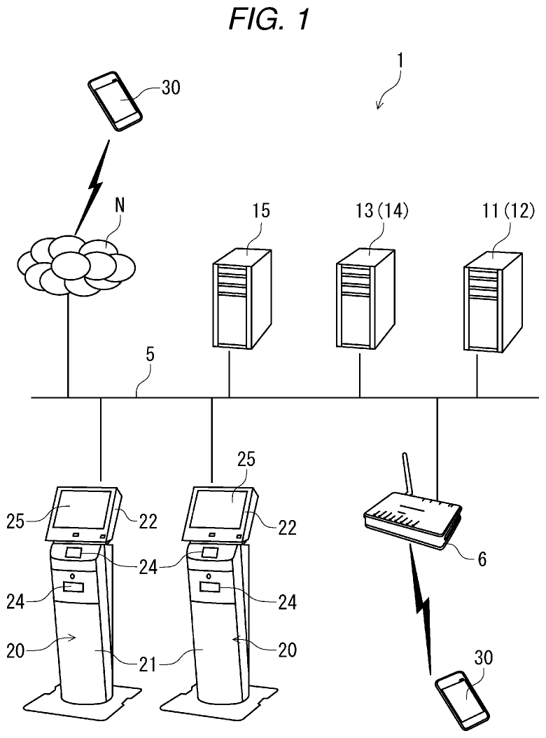

FIG. 1 is a schematic diagram illustrating a store stock notifying system 1 in the embodiment.

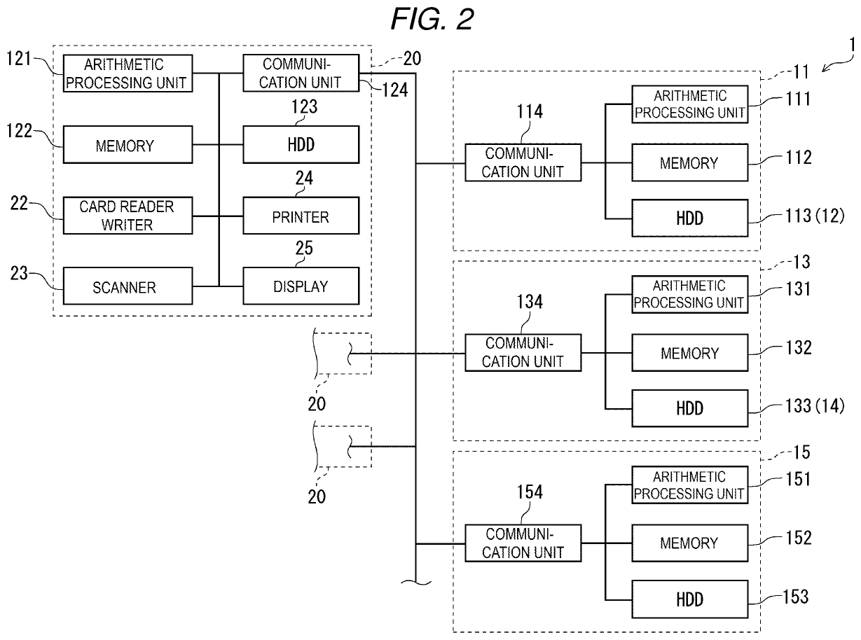

FIG. 2 is a diagram illustrating a hardware configuration of the store stock notifying system 1.

The store stock notifying system 1 includes a commodity stock management server 11, a customer information management server 13, a stock information provision server 15, and a storefront terminal 20.

The commodity stock management server 11 is a computer that manages stock information J4 of sales commodities in, for example, an electronics retail store or a supermarket. The commodity stock management server 11 includes an arithmetic processing unit 111, a memory 112, and a hard disk 113.

The commodity stock management server 11 includes a commodity stock database 12 in the hard disk 113. Commodity information is stored in the commodity stock database 12.

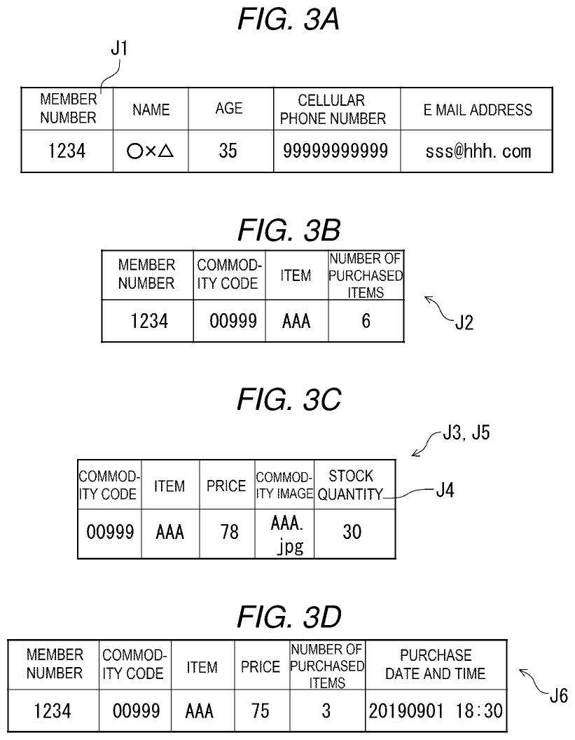

Commodity information J3 (J5) includes a commodity code, an item, a price, a commodity image, and the stock information J4 (see FIG. 3C).

The stock information J4 is a quantity of a commodity displayed in a store and is recorded on a real time basis, in a time unit, or in a day unit.

The customer information management server 13 is a computer that manages customer information. The customer information management server 13 includes an arithmetic processing unit 131, a memory 132, a hard disk 133, and a communication unit 134.

The customer information management server 13 includes a customer information database 14 in the hard disk 133. Customer information and commodity purchase history information J6 are stored in the customer information database 14.

The customer information includes a member number J1, a name, an age, and customer terminal information (a cellular phone number and an E mail address) (see FIG. 3A).

The commodity purchase history information J6 is information concerning commodities purchased in the past and includes the member number J1, a commodity code, an item, a price, the number of purchased items, and a purchase date and time (see FIG. 3D).

A member card is distributed to a customer registered in the customer information database 14. The member number J1 is described on the member card. The member number J1 is described on the member card by a barcode, a noncontact IC, or a QR code (a registered trademark).

The customer information can be extracted (retrieved) from the customer information database 14 by reading the member number J1 from the member card.

The stock information provision server (a purchase-planned-commodity registering unit or a stock-information notifying unit) 15 is a computer that provides a storefront stock state of a sales commodity to the customer. The stock information provision server 15 is also a computer that provides and manages a Web site (for example, an electronic commerce site).

The stock information provision server 15 includes an arithmetic processing unit 151, a memory 152, a hard disk 153, and a communication unit 154.

Various computer programs are saved in the hard disk 153 of the stock information provision server 15. For example, the computer programs include a program for causing the stock information provision server 15 to function as a purchase-planned-commodity registering unit that receives registration of a purchase planned commodity from the customer registered in the customer information database 14 and a stock-information notifying unit that, if a store visit of the customer is notified from the storefront terminal 20, acquires the stock information J4 of the purchase planned commodity from the commodity stock database 12 and notifies the stock information J4 to the customer.

The stock-information provision server 15 acquires the stock information J4 of the sales commodity from the commodity stock database 12 of the commodity stock management server 11. The stock information provision server 15 is connected to the Internet N and places the stock information J4 of the sales commodity on a Web site.

The customer operates a smartphone 30, a personal computer, or the like to access the Web site of the stock information provision server 15. The customer can acquire information such as presence or absence of commodities that the customer desires to purchase and the stock information J4 in this Web site.

The stock information provision server 15 can acquire information (a commodity name, a quantity, and the like) concerning the purchase planned commodity from the customer via the Internet N. In other words, the customer can register the purchase planned commodity in the Web site provided by the stock information provision server 15.

Specifically, the customer accesses the Web site from the information terminal such as the smartphone 30 and inputs the member number J1 to open a member only page (a my page). The my page is a customer exclusive page and is a page in which various kinds of information customized for each customer such as a my menu, a my news, a charge, and point information can be displayed and browsed.

The customer can create a shopping list in the member only page. The customer selects a commodity and the number of purchased items displayed in the Web site, whereby a shopping list is created.

The stock information provision server 15 transmits information (an item, the number of purchased items, and the like) of a commodity (AAA) listed in the shopping list to the customer information management server 13 and causes the customer information management server 13 to register the information in the customer information database 14 as purchase planned commodity information J2 (registration reception of the purchase planned commodity).

The purchase planned commodity information J2 includes a customer number, a commodity code, an item, and the number of purchased items (see FIG. 3B).

The storefront terminal (a customer-store-visit detecting unit) 20 is an information terminal set near an entrance of the store and is connected to the customer information management server 13 and the stock information provision server 15 via a LAN 5. The storefront terminal 20 includes an arithmetic processing unit 121, a memory 122, and a hard disk 123.

The storefront terminal 20 includes a card reader writer 22, a scanner 23, a printer 24, and a display 25. The customer visiting the store operates the storefront terminal 20 to thereby acquire customer information and the like from the card reader writer 22 and the like and cause the display 25 to display various kinds of information.

The storefront terminal 20 includes a housing 21 having a substantially square pole shape. The card reader writer 22, the scanner 23, and the printer 24 are disposed in the upper front of the housing 21. The display 25 is disposed at the top of the housing 21. Further, for example, a speaker (not illustrated in FIG. 1) that emits warning sound and sound guidance is provided in the storefront terminal 20.

The card reader writer 22 reads data from and writes data in the member card and the like.

The scanner 23 reads a barcode or a QR code (registered trademark) printed on a coupon or the like.

The printer 24 prints a receipt, a coupon, or the like and discharges the receipt, the coupon, or the like to the customer.

The display 25 displays various kinds of information. The display 25 is a so-called touch panel display. The customer can perform various kinds of operation on the display 25. For example, if the customer touches the display 25, a name of a product or a commodity recommended today, a price, an image, and the like of the product or the commodity are displayed on the display 25.

If visiting the store, the customer inserts the member card into the card reader writer 22 and causes the card reader writer 22 to read the member number J1. Consequently, the storefront terminal 20 detects the store visit of the customer registered in the customer information database 14. Note that a camera may be set in the storefront terminal 20 to photograph a face image of the customer. The storefront terminal 20 may detect the store visit of the customer by performing face authentication based on the photographed face image.

If detecting the store visit of the customer, the storefront terminal 20 displays, on the display 25, information customized for each customer. The storefront terminal 20 displays, for example, bargain information for members and point information for each customer. The storefront terminal 20 displays a coupon to urge print from the printer 24. Further, the storefront terminal 20 displays, on the display 25, for example, information concerning stock states and substitutes of commodities listed in a shopping list.

<Store Stock Notifying Method>

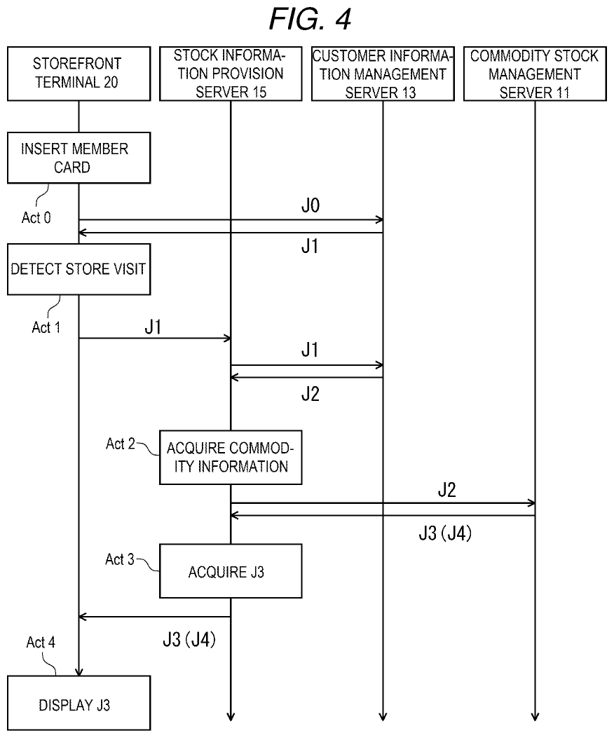

FIG. 4 is a sequence chart illustrating a store stock notifying method in the embodiment.

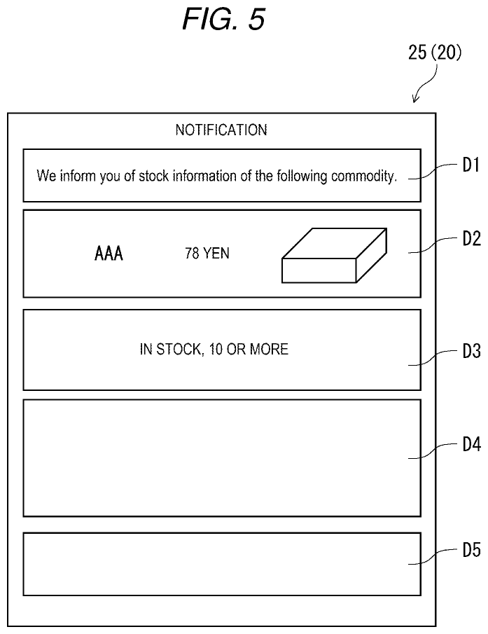

FIG. 5 is a diagram illustrating a display example of stock information of a purchase planned commodity.

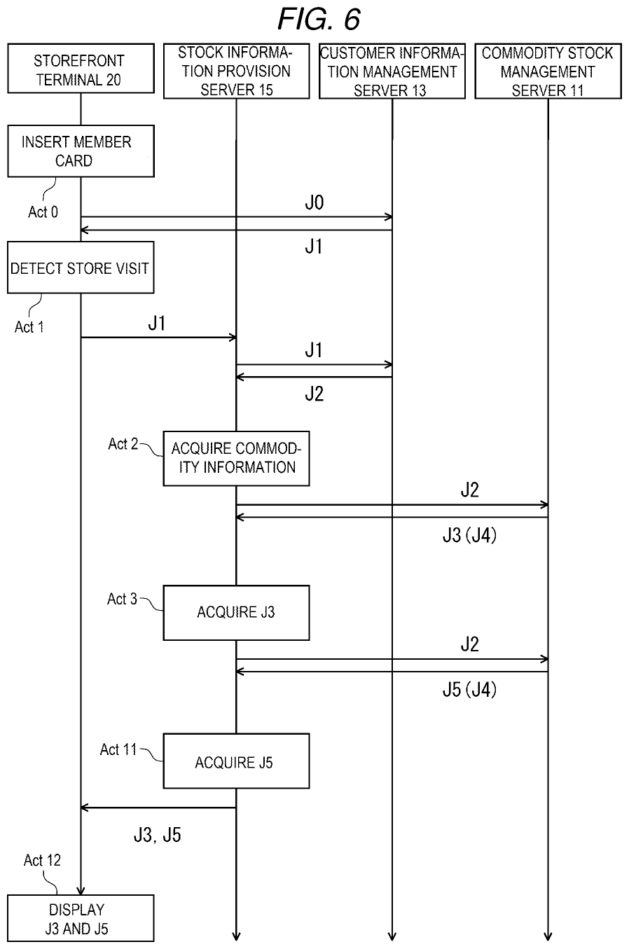

FIG. 6 is a sequence chart illustrating a modification of the store stock notifying method.

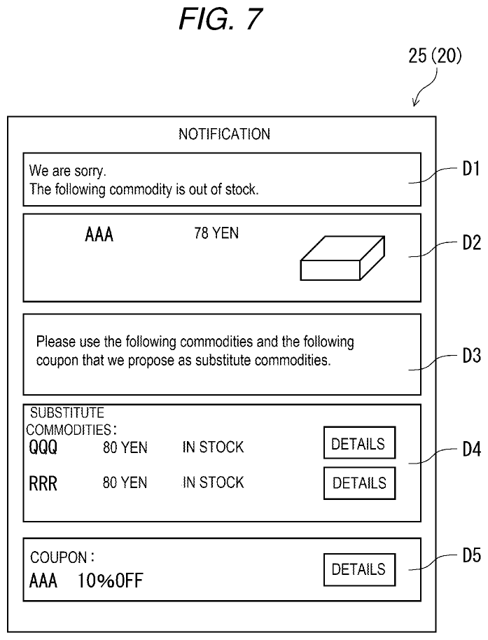

FIG. 7 is a diagram illustrating a display example of stock information of a purchase planned commodity.

In a store stock notifying method in the embodiment, first, the storefront terminal 20 detects a store visit of the customer registered in the customer information data base 14.

As explained above, if visiting the store, the customer inserts the member card into the card reader writer 22 and causes the card reader writer 22 to read a member number J0 (Act 0).

If reading the member number J0, the storefront terminal 20 transmits the member number J0 to the customer information management server 13 and instructs the customer information management server 13 to search through the customer information database 14.

If the member number J0 is registered in the customer information database 14, the customer information management server 13 returns the member number J1 to the storefront terminal 20.

The storefront terminal 20 determines (detects) that the customer having the member number J1 visits the store (Act 1).

The storefront terminal 20 transmits the member number J1 of the member (the customer) to the stock information provision server 15.

Subsequently, if receiving the member number J1, the stock information provision server 15 transmits the member number J1 to the customer information management server 13 and instructs the customer information management server 13 to search through the customer information database 14.

The customer information management server 13 retrieves the purchase planned commodity information J2 based on the member number J1 and returns the purchase planned commodity information J2 to the stock information provision server 15.

The stock information provision server 15 acquires the purchase planned commodity information J2 of the customer having the member number J1 (Act 2).

Subsequently, the stock information provision server 15 transmits the purchase planned commodity information J2 (a commodity code) to the commodity stock management server 11 and instructs the commodity stock management server 11 to search through the commodity stock database 12.

The commodity stock management server 11 retrieves the commodity information J3 based on the purchase planned commodity information J2 (the commodity code) and returns the commodity information J3 (an item, a price, the stock information J4, and the like) to the stock information provision server 15.

The stock information provision server 15 acquires the commodity information J3 (the stock information J4 and the like) of the purchase planned commodity (Act 3).

If a stock quantity of the purchase planned commodity is larger than or the same as a purchase planned quantity, the stock information provision server 15 transmits the commodity information J3 (the stock information J4 and the like) of the purchase planned commodity to the storefront terminal 20.

Subsequently, if receiving the commodity information J3 of the purchase planned commodity, the storefront terminal 20 displays the commodity information J3 of the purchase planned commodity on the display 25 (Act 4).

For example, as illustrated in FIG. 5, a message “We inform you of stock information of the following commodity” is displayed in a region D1 of the display 25.

An item and a price of a search target commodity are displayed in a region D2. Specifically, “AAA, 78 yen” is displayed. A thumbnail image of AAA is also displayed.

The stock information J4 is displayed in a region D3. Specifically, “in stock, 10 or more” is displayed.

A region D4 and a region D5 are blank (no display).

Consequently, the customer can learn a stock state of the purchase planned commodity (AAA) immediately after visiting the store.

If the stock quantity of the purchase planned commodity is smaller than the purchase planned quantity of the customer, the following processing is performed.

As illustrated in FIG. 6, the stock information provision server 15 transmits the purchase planned commodity information J2 (the commodity code) to the commodity stock management server 11 again and instructs the commodity stock management server 11 to search through the commodity stock database 12.

The commodity stock management server 11 retrieves the commodity information J3 based on the purchase planned commodity information J2 (the commodity code) and specifies a substitute (a different commodity of the same item or a similar item).

Similar commodity information is stored in the commodity information J3 as explained below.

For example, if a purchase planned commodity is fermented soybeans (AAA), fermented soybeans (QQQ) and fermented soybeans (RRR) are specified as substitutes (different commodities of the same item) and registered as the similar commodity information.

For example, if the purchase planned commodity is cabbage, lettuce and Chinese cabbage are specified as substitutes (similar items) and registered as the similar commodity information.

The commodity stock management server 11 returns the commodity information J5 (the stock information J4 and the like) of these substitutes to the stock information provision server 15.

In this way, the stock information provision server 15 acquires the commodity information J5 (the stock information J4, and the like) of the substitutes (Act 11).

The stock information provision server 15 transmits the commodity information J3 (the item, the stock information J4, and the like) of the search target commodity (AAA) and the commodity information J5 (the item, the stock information J4, and the like) of the substitutes (QQQ and RRR) respectively to the storefront terminal 20.

If receiving the commodity information J3 and J5, the storefront terminal 20 displays the commodity information J3 and J5 on the display 25 (Act 12).

For example, as illustrated in FIG. 7, a message “We are sorry. The following commodity is out of stock” (the stock information J4 of the search target commodity) is displayed in the region D1 of the display 25.

The item and the price of the search target commodity are displayed in the region D2. Specifically, “AAA, 78 yen” is displayed. The thumbnail image of AAA is also displayed.

A message “Please use the following commodities and the following coupon that we propose as substitute commodities” is displayed in the region D3.

The commodity information J5 (the stock information J4 and the like) of the substitutes is displayed in the region D4. Specifically, “QQQ, 80 yen, in stock” and “RRR, 85 yen, in stock” are displayed.

A “details” button is also displayed in the region D4. Detailed information of the substitutes (QQQ and RRR) can also be displayed by touching the “details” button.

Consequently, the customer can learn that the purchase planned commodity (AAA) is out of stock or short of stock immediately after visiting the store. The customer can also learn a stock state of the substitutes (QQQ and RRR). Therefore, the customer can determine, immediately after visiting the store, whether the customer gives up the store visit or purchases the substitutes.

Accordingly, the customer can avoid consuming a useless time for searching for the purchase planned commodity and the substitutes in the store. Dissatisfaction and distrust of the customer against the store can be eased.

If the stock quantity of the purchase planned commodity is smaller than the purchase planned quantity of the customer, a coupon may be issued.

As illustrated in FIG. 7, “Coupon: AAA, 10% OFF” is displayed in the region D5. A “details” button is also displayed in the region D5. The customer can also display or print the coupon by touching the “details” button.

Arrival schedule information of the purchase planned commodity may be provided. Further, the customer may be able to perform reserved purchase for the purchase planned commodity on the site (in the storefront terminal 20).

With such a method as well, dissatisfaction and distrust of the customer against the store can be eased.

In the embodiment explained above, the storefront terminal 20 receives the stock information J4 of the purchase planned commodity. Not only this, but a portable information terminal (the smartphone 30 or the like) carried by the customer may receive the stock information J4 of the purchase planned commodity.

The stock information provision server 15 acquires the E mail address and the cellar phone number of the customer included in the customer information and transmits the stock information J4 of the purchase planned commodity to the portable information terminal of the customer. At this time, the stock information provision server 15 may transmit the stock information J4 via a cellular phone line (an electric communication line). If the portable information terminal carried by the customer is connected to a wireless LAN 6 (an electric communication line) provided in the store, the stock information provision server 15 may transmit the stock information J4 via the wireless LAN 6.

As explained above, with the store stock notifying system and the store stock notifying method in the embodiment, the customer can learn the stock state of the purchase planned commodity immediately after visiting the store.

That is, if registration of the purchase planned commodity is received from the customer registered in the customer information database 14 and the store visit of the customer is detected by the storefront terminal 20, the stock information J4 of the purchase planned commodity is acquired from the commodity stock database 12 and notified to the customer.

The customer can also learn the stock state of the substitutes. Therefore, the customer can determine, immediately after visiting the store, whether the customer gives up the store visit or purchases the substitutes. Accordingly, dissatisfaction and distrust of the customer against the store can be eased.

Customer store visit detection is not limited to the detection of the customer store visit by the customer-action recognizing unit 20. A face image of a store visitor (a customer) may be photographed using a video camera disposed near the entrance of the store. Face authentication may be performed based on the photographed face image.

Detection of connection of the portable information terminal carried by the customer to the wireless LAN 6 provided in the store may be determined as the customer store visit.

Further, the customer store visit may be detected using position information (GPS information) of the portable information terminal carried by the customer.

As a method of registering the purchase planned commodity of the customer, use of a “shopping memo” provided in the Web site is explained above. However, the method is not limited to this. The commodity purchase history included in the customer information may be used. That is, the stock information provision server 15 may select a frequently purchased commodity or a periodically purchased commodity from the purchase history of the customer and automatically register the commodity as the purchase planned commodity.

The portable information terminal carried by the customer is not limited to the smartphone, the tablet terminal, and the personal computer and may be an artificial intelligence assistant terminal such as a so-called AI speaker, an artificial intelligence mounted refrigerator, or the like or may be an Iot device.

As the method of registering the purchase planned commodity of the customer, the method of registering the purchase planned commodity using the information terminal carried by the customer is explained above. However, not only this, but, for example, the purchase planned commodity may be registered using the storefront terminal 20 or the like.

The commodity stock management server 11, the customer information management server 13, and the stock information provision server 15 may be respectively individual computers or may be managed by one or two computers.

The store stock notifying system 1 is not limited to commodity stock management and registration of commodities desired to be dealt in in one store. The store stock notifying system 1 may perform commodity stock management and registration of commodities desired to be dealt in in a plurality of stores.

If the store stock notifying system 1 is applied in the plurality of stores, the store stock notifying system 1 may register a purchase planned store if registering the commodities desired to be dealt in. The store stock notifying system 1 may automatically set the purchase planned store according to position information (GPS information) of the portable information terminal carried by the customer.

A commercial transaction may not involve commodity purchase and sales. For example, this embodiment can also be applied in, for example, service provision such as use of a facility and goods rental.

The embodiment is presented as an example and are not intended to limit the scope of the invention. The new embodiment can be implemented in other various forms. Various omissions, substitutions, and changes can be made without departing from the spirit of the invention. The embodiment and modifications of the embodiments are included in the scope and the gist of the invention and included in the inventions described in claims and the scope of equivalents of the inventions.

What is claimed is:

1. A store stock notifying system, comprising:
a commodity stock database for managing stock information of commodities in a store;
a customer information database for managing customer information;
a purchase planned commodity registering component configured to receive registration of a purchase planned commodity from a customer registered in the customer information database;
a customer store visit detecting component configured to detect a store visit of the customer; and
a stock information notifying component configured to, if the customer store visit detecting component detects the store visit of the customer, acquire stock information of the purchase planned commodity from the commodity stock database and notify the stock information to the customer.

2. The store stock notifying system according to claim 1, wherein
the customer store visit detecting component is a storefront terminal, and
the stock information notifying component causes the storefront terminal to display the stock information.

3. The store stock notifying system according to claim 1, wherein
the customer information comprises information concerning a portable information terminal carried by the customer, and
the stock information notifying component transmits the stock information to the portable information terminal.

4. The store stock notifying system according to claim 3, wherein
the stock information notifying component transmits the stock information to the portable information terminal via an electric communication line.

5. The store stock notifying system according to claim 3, wherein
the stock information notifying component transmits the stock information to the portable information terminal via a wireless communication.

6. The store stock notifying system according to claim 1, wherein, if a stock quantity of the purchase planned commodity is smaller than a purchase planned quantity, the stock information notifying component acquires information concerning a substitute of the purchase planned commodity from the commodity stock database and notifies the information concerning the substitute to the customer.

7. The store stock notifying system according to claim 1, further comprising:
a generating component for generating a list of the purchase planned commodities for the customer.

8. The store stock notifying system according to claim 3, further comprising:
a generating component for generating a list of the purchase planned commodities for the customer; and
the notifying component sends the list of the purchase planned commodities to the portable information terminal carried by the customer.

9. A store stock notifying method, comprising:
receiving registration of a purchase planned commodity from a customer registered in a customer information database; and
if a store visit of the customer is detected by a customer store visit detecting component, acquiring stock information of the purchase planned commodity from a commodity stock database and notifying the customer with the stock information.

10. The store stock notifying method according to claim 9, further comprising:
displaying the stock information on a storefront terminal.

11. The store stock notifying method according to claim 9, further comprising:
transmitting the stock information to a portable information terminal carried by the customer.

12. The store stock notifying method according to claim 11, further comprising:
transmitting the stock information to the portable information terminal via an electric communication line.

13. The store stock notifying method according to claim 11, further comprising:
wirelessly transmitting the stock information to the portable information terminal.

14. The store stock notifying method according to claim 9, further comprising:
if a stock quantity of the purchase planned commodity is smaller than a purchase planned quantity, acquiring information concerning a substitute of the purchase planned commodity from the commodity stock database and notifying the information concerning the substitute to the customer.

15. The store stock notifying method according to claim 9, further comprising:
generating a list of the purchase planned commodities for the customer.

16. The store stock notifying method according to claim 11, further comprising:
generating a list of the purchase planned commodities for the customer; and
sending the list of the purchase planned commodities to the portable information terminal carried by the customer.

17. A non-transitory computer readable storage medium, comprising:
a memory that stores stock information of commodities in a store; and
a processor configured to:
receive registration of a purchase planned commodity from a customer registered in a customer information database; and
if a store visit of the customer is detected by a customer store visit detecting component, acquire stock information of the purchase planned commodity from a commodity stock database and notify the customer with the stock information.

18. The non-transitory computer readable storage medium according to claim 17, the processor further configured to:
display the stock information on a storefront terminal.

19. The non-transitory computer readable storage medium according to claim 17, the processor further configured to:
transmit the stock information to a portable information terminal carried by the customer.

20. The non-transitory computer readable storage medium according to claim 17, the processor further configured to:
if a stock quantity of the purchase planned commodity is smaller than a purchase planned quantity, acquire information concerning a substitute of the purchase planned commodity from the commodity stock database and notify the information concerning the substitute to the customer.
